(19) United States
(12) Patent Application Publication
(10) Pub. No.: US 2024/0250971 A1
(43) Pub. Date: Jul. 25, 2024

(54) DETECTING MALICIOUS USERS IN A DECENTRALIZED AUTONOMOUS ORGANIZATION

(71) Applicant: Capital One Services, LLC, McLean, VA (US)

(72) Inventors: Samuel RAPOWITZ, Roswell, GA (US); Michael MOSSOBA, Great Falls, VA (US); Dennis LIU, Richmond, VA (US); Austin ERICKSON, Herndon, VA (US)

(73) Assignee: Capital One Services, LLC, McLean, VA (US)

(21) Appl. No.: 18/159,654

(22) Filed: Jan. 25, 2023

(51) Int. Cl. H04L 9/40; H04L 9/00

(52) U.S. Cl. CPC H04L 63/1425; H04L 9/50; G07C 13/00

(57) ABSTRACT

Methods and systems disclosed herein may detect a malicious user by scanning the messaging platform with the members for any malicious content using sentiment detection. Sentiment detection may be performed using a machine learning model or another type of sentiment detection. For example, the machine learning model may detect a malicious comment and then determine whether the user is malicious using a variety of behavior patterns. For example, the machine learning model may use factors like reactions from the community, sentiment analysis, and the number of posts to determine whether the user is malicious. By doing so, the system is able to search constantly for users that may be malicious.

### BACKGROUND

In recent years, the use of blockchain technology has increased. A blockchain is essentially a digital ledger of transactions that is duplicated and distributed across an entire network of computer systems hosting the blockchain. That is, the digital ledger of a blockchain is a decentralized source of information that does not require a central authority to monitor transactions, maintain records, and/or enforce rules. Blockchain technology is now being used to create decentralized autonomous organizations (DAO). A DAO is an entity structure where members vote on actions to take, and then a smart contract implements the results of the vote. The DAO benefits from blockchain technology that allows for the recording of information that is difficult or impossible to change. As mentioned above, DAOs rely on smart contracts. DAO smart contracts may be designed in such a manner that members with larger numbers of cryptographic tokens associated with the DAO have a larger impact on voting outcomes. In this example, a malicious user may acquire a large number of the cryptographic tokens and vote for actions that negatively impact the rest of the members in the DAO or that negatively impact the DAO itself. However, it is difficult to detect a malicious user within a DAO as users are generally anonymous. As members within the DAO may decide to invest their money into a decentralized autonomous organization token to ensure that members within the DAO are protected against malicious actions, a mechanism to recognize malicious users within a DAO is desirable.

### SUMMARY

One mechanism to detect malicious users in a DAO may use blockchain technology and artificial intelligence models. Methods and systems disclosed herein may detect a malicious user by scanning a messaging platform, using sentiment detection, associated with the DAO for any malicious content. Sentiment detection may be performed using a machine learning model or another type of sentiment detection. For example, the machine learning model may detect a malicious comment and then determine whether the user is malicious using a variety of behavior patterns. For example, the machine learning model may use factors like reactions from the community, sentiment analysis, and the number of posts to determine whether the user is malicious. When a malicious user is detected, the system may enable a vote on removing the user from the DAO. In some embodiments, the system may remove the user from the DAO or somehow flag the user automatically.

In some aspects, the problems above may be solved using a malicious user detection system. The malicious user detection system may scan a messaging platform. In particular, the malicious user detection system may scan a messaging platform associated with a DAO for comments associated with a user (e.g., generated by the user). For example, the malicious user detection system may scan a messaging platform (e.g., Discord) for malicious messages by extracting the messages and performing sentiment detection on those messages.

The malicious user detection system may determine whether the user is associated with negative sentiment. In particular, the malicious user detection system may determine whether the comments associated with the user cause the user to be associated with a negative sentiment. For example, the malicious user detection system may analyze comments made by the user using natural learning processing techniques such as sentiment analysis to determine whether the user should be associated with a negative sentiment. For example, the user may comment, “This token is nonsense.” The machine learning model may flag this as negative sentiment towards the DAO.

The malicious user detection system may retrieve token identifiers that correspond to the cryptographic tokens controlled by a cryptography-based storage application of the user. In particular, the malicious user detection system may retrieve, from a blockchain node, a plurality of token identifiers corresponding to a plurality of cryptographic tokens controlled by a cryptography-based storage application of the user. For example, when the malicious user detection system is assessing whether the user is malicious, the malicious user detection system may retrieve an identifier of the user device (e.g., a smartphone) that hosts a cryptographic wallet that is able to control cryptographic tokens associated with the DAO. As such, when a user is associated with negative sentiment, the malicious user detection system may receive a list of cryptographic tokens controlled by the cryptographic wallet of the user. The system may analyze the list of cryptographic tokens to acquire information associated with those cryptographic tokens.

Furthermore, the malicious user detection system may determine whether the user's cryptographic wallet controls any cryptographic tokens deemed adverse to the DAO. In particular, the malicious user detection system may determine, based on the plurality of token identifiers, whether the user controls cryptographic tokens deemed adverse to the DAO. For example, a user may be a part of two different DAOs, and both DAOs may have attempted or are attempting to purchase the same fantasy sports team. The DAOs would now be adverse to one another as they are competing for the same purchase. Thus, the malicious user detection system may determine whether the user device hosts a cryptographic wallet that controls any cryptographic tokens associated with the adverse DAO.

Based on the determinations above, the malicious user detection system may determine whether the user is malicious. In particular, the malicious user detection system may determine, based on whether the comments associated with the user cause the user to be associated with the negative sentiment and based on whether the user controls the cryptographic tokens deemed adverse to the DAO, whether the user is malicious. That is, the malicious user detection system may determine whether the user is malicious using the results of the malicious message detection machine learning model and sentiment analysis. For example, the user may have said, “this token sucks,” and the user also controls many cryptographic tokens that are associated with a competing DAO. Therefore, the system may determine that the user's goal is to negatively impact the DAO.

In some embodiments, the malicious user detection system may initiate a vote to determine whether to remove the user from the DAO. In particular, in response to determining that the user is malicious, the malicious user detection system may initiate a voting system to determine whether to remove the user from the DAO. For example, the malicious user detection system may send a voting request to the members of the DAO on whether to remove the malicious user. For example, after the machine learning model has flagged the user for negative sentiment and it has been determined that the user controls cryptographic tokens for one or more competing DAOs, the system may send a voting request to each member or some members within the DAO.

In some embodiments, the malicious user detection system may remove the user from the DAO. In particular, the malicious user detection system may in response to determining to remove the user from the DAO, retrieve a cryptographic address associated with the cryptography-based storage application of the user. Then, the malicious user detection system may transmit a command to an on-chain program to add the cryptographic address to a blocklist. The on-chain program may prevent cryptographic addresses on the blocklist from controlling any cryptographic tokens associated with the DAO. Thus, the malicious user detection system may remove the user from the DAO by adding the cryptographic address associated with the user to a blocklist, thereby preventing the user from transferring those cryptographic tokens to be controlled by another blockchain address.

In some embodiments, the malicious user detection system may remove the cryptographic address associated with the malicious user from any cryptographic tokens associated with the DAO. In particular, the malicious user detection system may in response to determining to remove the user from the DAO, trigger the on-chain program to remove a cryptographic address associated with the cryptography-based storage application of the user as a controlling address of one or more cryptographic tokens associated with the DAO. For example, the malicious user detection system may trigger an existing on-chain program. The cryptographic tokens may be controlled by specific cryptographic addresses written in a particular field within the token. Thus, the system may remove a cryptographic address associated with the cryptographic wallet of the user as a controlling address of one or more cryptographic tokens associated with the DAO.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for detecting a malicious user in a decentralized autonomous organization, in accordance with one or more embodiments.

FIG. 2 illustrates a data structure of user messages for detecting a malicious user in a decentralized autonomous organization, in accordance with one or more embodiments.

FIG. 3 shows illustrative components for a system using a machine learning model for detecting a malicious user in a decentralized autonomous organization, in accordance with one or more embodiments.

FIG. 4 illustrates a data structure representing a list of token identifiers, in accordance with one or more embodiments.

FIG. 5 illustrates a data structure that stores registration information of a plurality of users, in accordance with one or more embodiments.

FIG. 6 illustrates a data structure representing a voting request, in accordance with one or more embodiments.

FIG. 7 shows a flowchart of the steps involved in detecting a malicious user in a decentralized autonomous organization, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

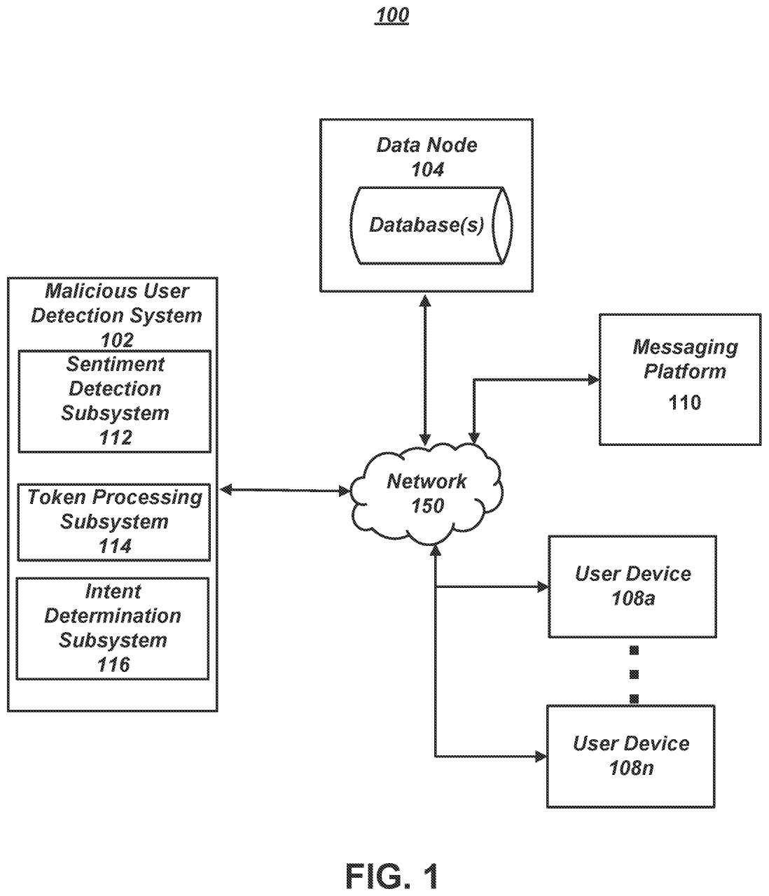

FIG. 1 shows an example of an environment 100 for detecting a malicious user in a DAO. Environment 100 includes malicious user detection system 102, data node 104, user devices 108a-108n, and messaging platform 110. Malicious user detection system 102 may execute instructions for detecting a malicious user in a DAO using a variety of behavior patterns. Malicious user detection system 102 may include software, hardware, or a combination of the two. For example, malicious user detection system 102 may be hosted on a physical server or a virtual server that is running on a physical computer system. In some embodiments, malicious user detection system 102 may be configured on a user device (e.g., a laptop computer, a smartphone, a desktop computer, an electronic tablet, or another suitable user device).

User devices 108a-108n may include any suitable end-user computing devices (e.g., desktop computers, laptops, electronic tablets, smartphones, and/or other computing devices used by end users) capable of transmitting and receiving data such as requests and/or transactions.

Malicious user detection system 102 may scan messaging platform 110 for messages from various users. In particular, malicious user detection system 102 may scan messaging platform 110 associated with a DAO for comments associated with a user. Messaging platform 110 may include software components, hardware components, or a combination of both. For example, messaging platform 110 may include software components (e.g., code) that allow users to communicate with one another on the messaging platform. Some examples of messaging platforms include Discord, Telegram, WhatsApp, etc. Messaging platform 110 may display content generated by users. As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, electronic books, blogs, advertisements, chat sessions, social media content, and/or any other media or multimedia and/or combination of the same that may be generated or copied by a particular user. Content may be recorded, played, displayed, or accessed by user devices.

For example, malicious user detection system 102 may scan messaging platform 110 (e.g., Discord) using sentiment detection subsystem 112. Sentiment detection subsystem 112 may include software components, hardware components, or a combination of both. For example, sentiment detection subsystem 112 may include a network card (e.g., a wireless network card and/or a wired network card) that is associated with software to drive the card. In some embodiments, the sentiment detection subsystem 112 may scan messaging platform 110 in response to detecting, in the messaging platform (e.g., messaging platform 110), a malicious comment associated with the user. In some embodiments, sentiment detection subsystem 112 may include a communication module (e.g., including hardware such as a network card and software to drive that network card). Sentiment detection subsystem 112 may transmit a request to messaging platform 110 (e.g., via an application programming interface published by messaging platform 110) and receive in response a plurality of messaging and corresponding user identifiers. In some embodiments, malicious user detection system 102 may store user identifiers and corresponding cryptographic addresses for those users. Thus, sentiment detection subsystem 112 may determine which user generated which message.

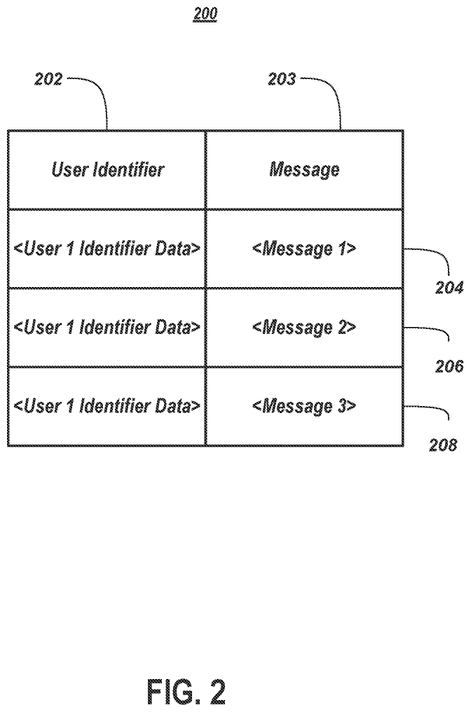

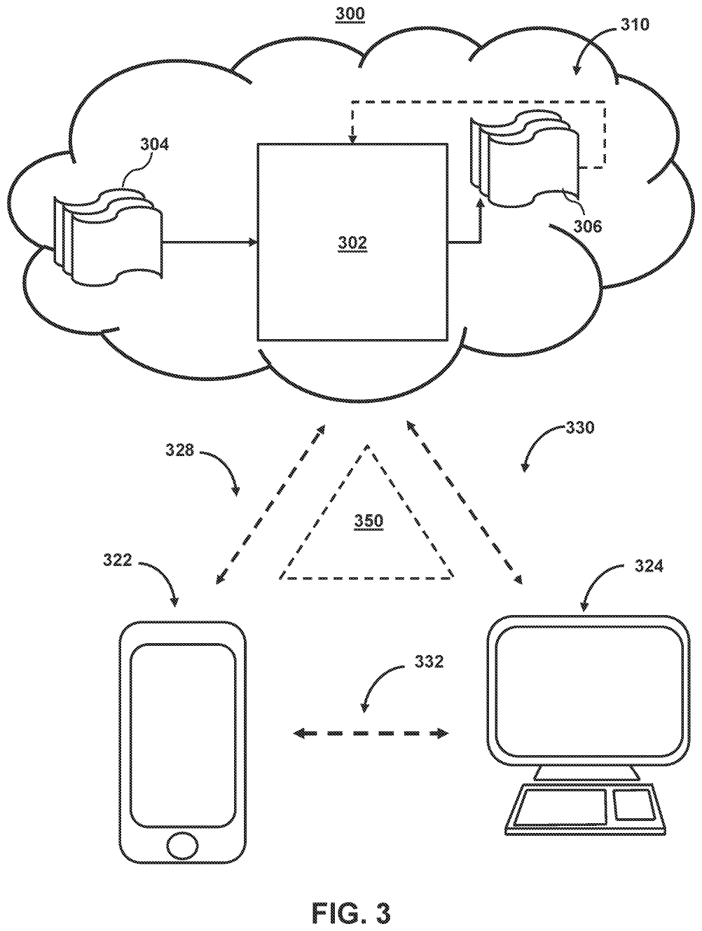

Malicious user detection system 102 may determine whether the user is associated with negative sentiment. In particular, malicious user detection system 102 may determine whether the comments associated with the user cause the user to be associated with a negative sentiment. For example, malicious user detection system 102 may analyze comments made by the user using natural learning processing techniques such as sentiment analysis to determine whether the user should be associated with a negative sentiment. For example, the user may comment, “This token is nonsense.” The machine learning model may flag such comment with a negative sentiment identifier. Components of the determination are described further herein with references to FIG. 2 and FIG. 3.

FIG. 2 illustrates a data structure 200 of exemplary user messages for detecting malicious users in a DAO. Data structure 200 may include user identifier column 202, message column 203, and messages 204, 206, and 208. For example, each user identifier 202 may include an identifier for a user account. In some embodiments, each user identifier 202 may be stored within malicious user detection system 102 and may have a corresponding cryptographic address associated with a cryptography-based storage application (e.g., each user identifier may be associated with a cryptographic wallet). Messages 204, 206, and 208 may include any content received by messaging platform 110 from the corresponding. For example, messages 204, 206, and 208 may include communications from a user device (e.g., a smartphone, laptop, etc.) through the messaging platform. In some embodiments, malicious user detection system 102 may store data structure 200 on data node 104.

Data node 104 may store various data, including user data, copies of on-chain programs, and/or other suitable data. Data node 104 may include software, hardware, or a combination of the two. For example, data node 104 may be a physical server or a virtual server that is running on a physical computer system. In some embodiments, malicious user detection system 102 and data node 104 may reside on the same hardware and/or the same virtual server/computing device. Network 150 may be a local area network (LAN), a wide area network (WAN) such as the Internet, or a combination of the two.

FIG. 3 shows illustrative components for a system using a machine learning model for detecting a malicious user in a DAO. For example, FIG. 3 may show illustrative components for using a machine learning model to determine whether the user is associated with negative sentiment. As shown in FIG. 3, system 300 may include mobile device 322 and user terminal 324. Each of mobile device 322 and user terminal 324 may be user devices that are used by users to send messages to a messaging platform (e.g., messaging platform 110). While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. In some embodiments, malicious user detection system 102 may be one of cloud components 310. Cloud components 310 may alternatively be any computing device as described above and may include any type of mobile terminal, fixed terminal, or any other device. For example, cloud components 310 may be implemented as a cloud computing system and may feature one or more component devices. It should also be noted that system 300 is not limited to three devices. Users may for instance, utilize one or more devices to interact with one another, one or more servers, or other components of system 300. It should be noted that while one or more operations are described herein as being performed by particular components of system 300, these operations may in some embodiments, be performed by other components of system 300. As an example, while one or more operations are described herein as being performed by components of mobile device 322, these operations may in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may include any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred to collectively as “models” herein). Model 302 may take inputs 304 and provide outputs 306. For example, model 302 may take inputs 304 (e.g., messages 204, 206, and 208) and provide determinations of whether the user is associated with negative sentiment towards the DAO. In some embodiments, outputs 306 may be fed back to model 302 as input to train model 302 (e.g., alone or in conjunction with user indications of the accuracy of outputs 306, labels associated with the inputs, or with other reference feedback information).

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained rather than explicitly programmed and can perform significantly better in certain areas of problem-solving as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, backpropagation techniques may be utilized by model 302, where forward stimulation is used to reset weights on the “front” neural units. In some embodiments, stimulation and inhibition for model 302 may be more free-flowing, with connections interacting in a more chaotic and complex fashion.

In some embodiments, the model (e.g., model 302) may automatically perform actions based on outputs 306. In some embodiments, the model (e.g., model 302) may not perform any actions. The output of the model (e.g., model 302) may be used to optimize the model.

System 300 also includes API layer 350. API layer 350 may allow the system to generate summaries across different devices. In some embodiments, API layer 350 may be implemented on a user device such as mobile device 322 or user terminal 324. Alternatively, or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of their operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is a strong adoption of SOAP and RESTful Web services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API Platforms and their modules. API layer 350 may use a developer portal. API layer 350 may use strong security constraints applying WAF and DDoS protection, and API layer 350 may use RESTful APIs as standard for external integration. In some embodiments, malicious user detection system 102 may use the API layer to communicate with messaging platform 110 and/or other devices.

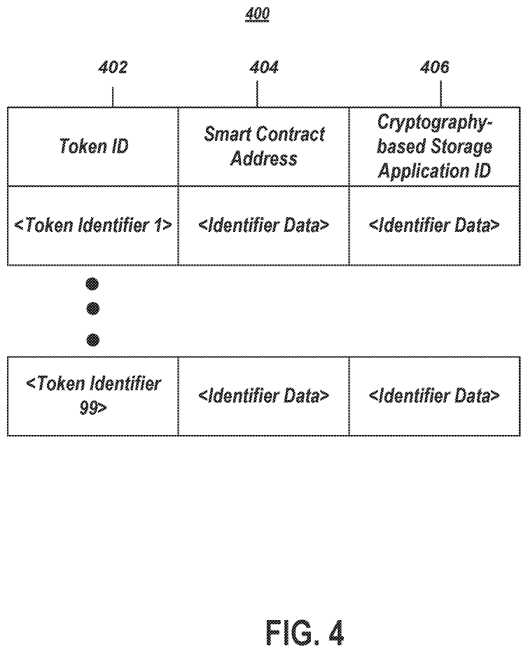

As discussed above, malicious user detection system 102 may determine, using a machine learning model and based on messages received from a messaging platform, whether a user is malicious. Additionally, or alternatively, malicious user detection system 102 may determine whether the user is malicious based on a user controlling cryptographic tokens associated with other DAOs. Thus, malicious user detection system 102 may retrieve token identifiers that correspond to the cryptographic tokens controlled by a cryptography-based storage application of the user. In particular, malicious user detection system 102 may retrieve, from a blockchain node, a plurality of token identifiers corresponding to a plurality of cryptographic tokens controlled by a cryptography-based storage application of the user. For example, when the malicious user detection system is assessing whether the user is malicious, malicious user detection system 102 may retrieve an identifier of the user device (e.g., an identifier of a smartphone) that hosts a cryptography-based storage application (e.g., a digital wallet) that is able to control cryptographic tokens associated with the DAO. As such, malicious user detection system 102 may receive a list of fungible tokens, non-fungible tokens, and/or other types of cryptographic tokens. Malicious user detection system 102 may analyze the list of cryptographic tokens to acquire information associated with those cryptographic tokens. Components of the token identifiers are described further herein with reference to FIG. 4.

FIG. 4 illustrates a data structure 400 representing an explementary list of token identifiers generated by token processing subsystem 114. Token processing subsystem 114 may include software components, hardware components, or a combination of both. For example, token processing subsystem 114 may include software components that access and/or execute programs such as on-chain programs to generate tokens (e.g., cryptographic tokens). Data structure 400 may include token identifier 402, smart contract address 404, and cryptography-based storage application identifier 406. Token identifier 402 may be an identifier for the cryptographic token. Token identifier 402 may have a value such as an unsigned integer value from 8 bits to 256 bits. In some embodiments, the term token identifier refers to an address (e.g., an identifier) associated with a cryptography-based storage application that is able to transfer the cryptographic token to be controlled by another cryptography-based storage application by signing a blockchain operation (e.g., a blockchain transaction) with a private key associated with the cryptography-based storage application that controls the cryptographic token prior to transfer. Smart contract address 404 may have a value identifying an on-chain program that generated (e.g., minted) the cryptographic token.

Malicious user detection system 102 may determine whether the user controls any cryptographic tokens deemed adverse to the DAO. In particular, malicious user detection system 102 may determine, based on the plurality of token identifiers being controlled by the user's cryptographic address, whether the user's cryptographic address (e.g., associated with the user's cryptography-based storage application) controls cryptographic tokens deemed adverse to the DAO. For example, a user's cryptographic address may control cryptographic tokens associated with two different DAOs, and both DAOs may have attempted to or may be attempting to bid for the same token distribution. The DAOs would now be adverse to one another as they are competing for the same purchase. Thus, malicious user detection system 102 may determine whether the user device hosts a digital wallet that controls any cryptographic tokens associated with the adverse DAO. In some embodiments, malicious user detection system 102 may store a listing of cryptographic token identifiers and/or on-chain program addresses (e.g., smart contracts) corresponding to adverse DAOs. Thus, to determine whether a particular cryptographic token controlled by the user is associated with an adverse DAO, malicious user detection system 102 may compare the token identifiers within the list to the token identifier controlled by the user.

To determine whether a user has control of cryptographic tokens that are adverse to the DAO and to subsequently enable blocking a transfer of cryptographic tokens, malicious user detection system 102 may require a cryptographic address associated with a cryptography-based storage application of the user (e.g., a user's wallet address). Malicious user detection system 102 may use a registration process (e.g., registration for messaging platform 110) to acquire the cryptographic address of the user. In some embodiments, malicious user detection system 102 may require that the user prove that the user controls the cryptographic address by requiring a user to sign a blockchain operation with a corresponding cryptography-based storage application.

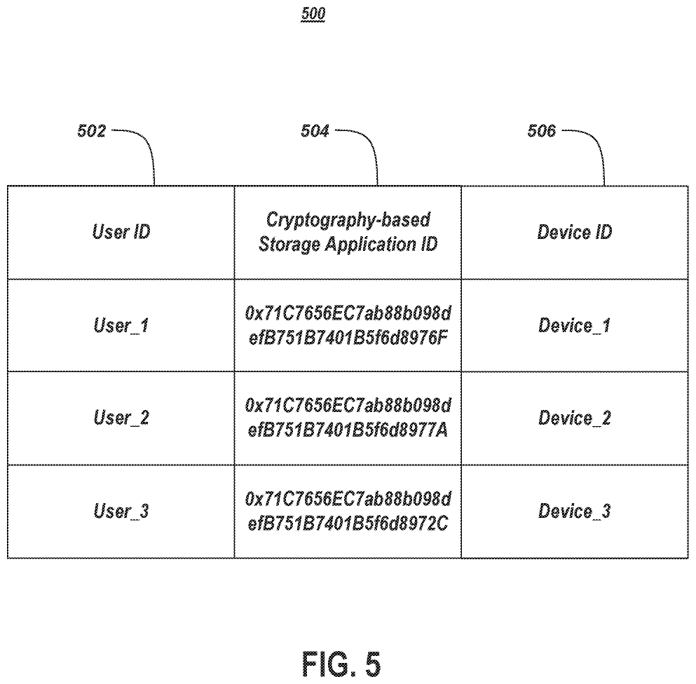

FIG. 5 illustrates a data structure 500 that stores the registration information of a plurality of users. Data structure 500 may include user identifier 502 and cryptography-based storage application identifier 504, and device identifier 506. In some embodiments, data structure 500 may include other fields (not shown). In some embodiments, malicious user detection system 102 may receive a request from a user device to join the DAO and/or join messaging platform 110. In particular, malicious user detection system 102 may receive a request to join the DAO. The request may be received from a user device (e.g., a user device of user devices 108a-108n). For example, a user may use a web browsing application or another application on a user device (e.g., an app on a smartphone) to connect to the server enabling the registration process described above. The server may execute an application that is enabled to detect a cryptographic address associated with the user's device (e.g., with the user's cryptography-based storage application hosted on the user's device). In some embodiment, the application may be a decentralized application, sometimes referred to as a Dapp.

Malicious user detection system 102 may identify a cryptographic address associated with the cryptography-based storage application of the user. In some embodiments, malicious user detection system 102 may be hosted on the same computing device (e.g., server) hosting the registration process for the DAO. Thus, when the user device connects to the application on the server (e.g., to the Dapp), the application may read the user's cryptographic address and pass it on to the malicious user detection system 102. Malicious user detection system 102 may store the cryptographic address and a user identifier of the user, for example, in a database. Thus, during the registration process, malicious user detection system 102 may add a new user identifier 502 and a new cryptography-based storage application identifier 504 to data structure 500. As a result, the system may be able to search through the cryptographic tokens for any that are controlled by malicious users. Device identifier 506 may be used to transmit messages from the DAO to each user (e.g., to indicate that a vote is open for a particular issue).

In some embodiments, malicious user detection system 102 may use token identifiers of tokens controlled by the user in combination with the user's cryptographic address (discussed above) to determine whether the user controls cryptographic tokens controlled by an adverse DAO. In particular, malicious user detection system 102 may determine whether the user controls the cryptographic tokens deemed adverse to the DAO by retrieving a first plurality of token identifiers associated with the cryptographic tokens associated with a different DAO. For example, malicious user detection system 102 may store a listing of cryptographic tokens associated with adverse DAOs. The listing may be a list of cryptographic addresses associated with those tokens and/or smart contracts that generated (e.g., minted those tokens). The listing may be stored in a database (e.g., in a database of data node 104). Malicious user detection system 102 may retrieve, based on the cryptographic address, a second plurality of token identifiers associated with tokens controlled by the cryptography-based storage application of the user. For example, malicious user detection system 102 may query a blockchain node for blockchain data related to the user's cryptographic address (e.g., the cryptographic address associated with a cryptography-based storage application of the user). Malicious user detection system 102 may receive the blockchain data and extract token identifiers and/or on-chain program identifiers (e.g., smart contract addresses).

Malicious user detection system 102 may then determine whether one or more token identifiers of the first plurality of token identifiers match a token identifier in the second plurality of token identifiers. For example, malicious user detection system 102 may compare the token identifiers (e.g., token addresses) associated with tokens of any adverse DAOs with token identifiers of tokens controlled by the cryptography-based storage application associated with the user. If malicious user detection system 102 identifies any matching token identifiers, then malicious user detection system 102 may determine that the user controls cryptographic tokens associated with an adverse DAO. In some embodiments, malicious user detection system 102 may compare on-chain program addresses (e.g., smart contract addresses) associated with cryptographic tokens controlled by the user's cryptography-based storage application with on-chain program addresses (e.g., smart contract addresses) associated with adverse DAOs (e.g., stored in a database). If there is a match based on on-chain addresses, malicious user detection system 102 may determine that the user controls cryptographic tokens associated with an adverse DAO. In some embodiments, once the system has identified negative sentiment associated with a user, token processing subsystem 114 may search for cryptographic tokens controlled by the user that are associated with an adverse DAO. That is, in those embodiments, identifying a negative sentiment may be a trigger to attempting to determine whether the user controls cryptographic tokens associated with an adverse DAO.

When malicious user detection system 102 determines whether the user is associated with a negative sentiment and/or whether the user controls cryptographic tokens of an adverse DAO, malicious user detection system 102 may determine whether the user is malicious. In particular, malicious user detection system 102 may determine, based on whether the comments associated with the user cause the user to be associated with the negative sentiment and on whether the user controls the cryptographic tokens deemed adverse to the DAO, whether the user is malicious. For example, the user may have said, “this token sucks,” and the user also controls a plurality of cryptographic tokens that are associated with an adverse DAO. Therefore, malicious user detection system 102 may determine that the user's goal is to negatively impact the DAO. In some embodiments, malicious user detection system 102 may determine whether the user is malicious using intent determination subsystem 116.

Intent determination subsystem 116 may include software components, hardware components, or a combination of both. For example, intent determination subsystem 116 may include a network card (e.g., a wireless network card and/or a wired network card) that is associated with software to drive the card. In some embodiments, intent determination subsystem 116 may determine whether the user is malicious using a variety of behavior patterns. For example, intent determination subsystem 116 may determine whether a user is malicious using the results of model 302 and data structure 400.

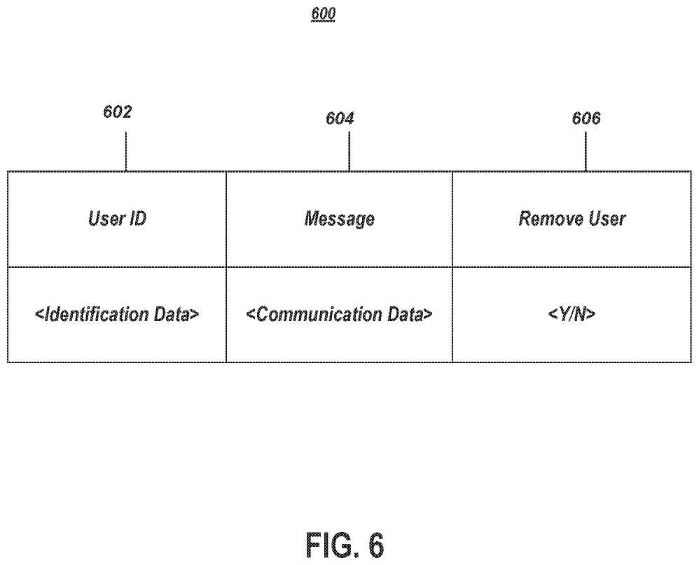

Malicious user detection system 102 may initiate a vote to determine whether to remove the user from the DAO. In particular, in response to determining that the user is malicious, malicious user detection system 102 may initiate a voting system to determine whether to remove the user from the DAO. For example, malicious user detection system 102 may send a voting request to the members of the DAO on whether to remove the malicious user. Malicious user detection system 102 may send a voting request using messaging platform 110. For example, as illustrated in FIG. 5, malicious user detection system 102 may store device identifiers for user devices (e.g., client devices 108a-108n). Malicious user detection system 102 may send the voting requests using those device identifiers through messaging platform 110. In some embodiments, after the machine learning model (e.g., model 302) has flagged the user for negative sentiment, and it has been determined that the user controls cryptographic tokens for one or more adverse DAOs, malicious user detection system 102 may send a voting request to each member within the DAO. Components of the voting request to remove the malicious user are described further herein with reference to FIG. 6.

FIG. 6 illustrates a data structure 600 representing a voting request for detecting a malicious user in a DAO. Data structure 600 may include user identifier 602, message 604, and remove user field 606. In some embodiments, when the DAO votes to remove the user from the DAO, malicious user detection system 102 may remove the cryptographic address associated with the malicious user from any cryptographic tokens associated with the DAO. In particular, malicious user detection system 102 may in response to determining to remove the user from the DAO, trigger an on-chain program to remove a cryptographic address associated with the cryptography-based storage application of the user (e.g., cryptography-based storage application identifier 504) as a controlling address of one or more cryptographic tokens associated with the DAO. For example, malicious user detection system 102 may trigger an existing on-chain program. The cryptographic tokens may be controlled by specific cryptographic addresses written in a particular field within the token. Thus, the malicious user detection system may remove a cryptographic address associated with the digital wallet of the user as a controlling address of one or more cryptographic tokens associated with the DAO.

In some embodiments, malicious user detection system 102 may initiate a voting process to determine whether to remove a malicious user from the DAO using the following operations. In particular, malicious user detection system 102 may retrieve a user identifier of the user (e.g., user identifier 602). The user identifier may be the same user identifier used to register the user. Based on the user identifier, malicious user detection system 102 may determine a device identifier associated with the user (e.g., via a data structure illustrated in FIG. 5). Malicious user detection system 102 may then transmit a voting request to each computing device associated with the DAO (e.g., to each computing device registered with the system as illustrated in FIG. 5). The voting request may include the user identifier (e.g., user identifier 602) of the user determined to be malicious and a message indicating that the user is malicious (e.g., message 604). The voting request may prompt the receiving users to indicate whether the user should be removed from the DAO (e.g., remove user field 606). For example, the system may send a voting request to all the members of the DAO to remove the user. In some embodiments, the prompt may be selectable. When a receiving user selects the prompt, malicious user detection system 102 may open an application (e.g., a decentralized application) on the device of the user. The application may retrieve a cryptographic address associated with the user's cryptography-based storage application and may enable the user to vote by submitting a signed (e.g., signed by a private key of the user) blockchain operation through the application (e.g., through the decentralized application) to the blockchain (e.g., via a blockchain node). If the results of the vote indicate that the user should be removed from the DAO, the malicious user detection system 102 may remove the detected malicious user from the DAO (e.g., by disabling control of the cryptographic tokens from the user's cryptographic address and/or removing the user from the messaging platform).

In some embodiments, malicious user detection system 102 may perform the following operations to remove the detected malicious user. In particular, malicious user detection system 102 may, in response to determining to remove the user from the DAO, retrieve a cryptographic address associated with the cryptography-based storage application of the user. For example, as illustrated in FIG. 5, malicious user detection system 102 may determine, based on the user identifier 502 of the user, a cryptography-based storage application identifier 504. In some embodiments, cryptography-based storage application identifier 504 may be a cryptographic address of the user that controls cryptographic tokens (e.g., a wallet address of the user). Malicious user detection system 102 may transmit a command to an on-chain program to add the cryptographic address to a blocklist. For example, the on-chain program may be associated with the DAO and may be used to transfer controls of cryptographic tokens from one cryptographic address to another cryptographic address. Thus, the on-chain program may prevent a particular cryptographic address on the blocklist from controlling (e.g., transferring) any cryptographic tokens associated with the DAO. In some embodiments, the on-chain program may stop the cryptographic address from performing other actions (e.g., voting). Thus, the system may block the malicious user from controlling any more cryptographic tokens associated with the DAO. Therefore, the detected malicious user is no longer able to participate in the DAO.

In some embodiments, malicious user detection system 102 may remove a malicious user from the DAO using the following operations. In particular, malicious user detection system 102 may retrieve a cryptographic address associated with the cryptography-based storage application of the user (e.g., as described above). Malicious user detection system 102 may then determine, via the blockchain node, one or more cryptographic tokens associated with the DAO (e.g., based on blockchain data and or on-chain program data) that are controlled by the cryptographic address. Malicious user detection system 102 may remove the cryptographic address from a control field within one or more cryptographic tokens. For example, malicious user detection system 102 may add an invalid address to the control field, thus “burning” the cryptographic tokens. As a result, the malicious user may no longer control any existing cryptographic tokens associated with the DAO.

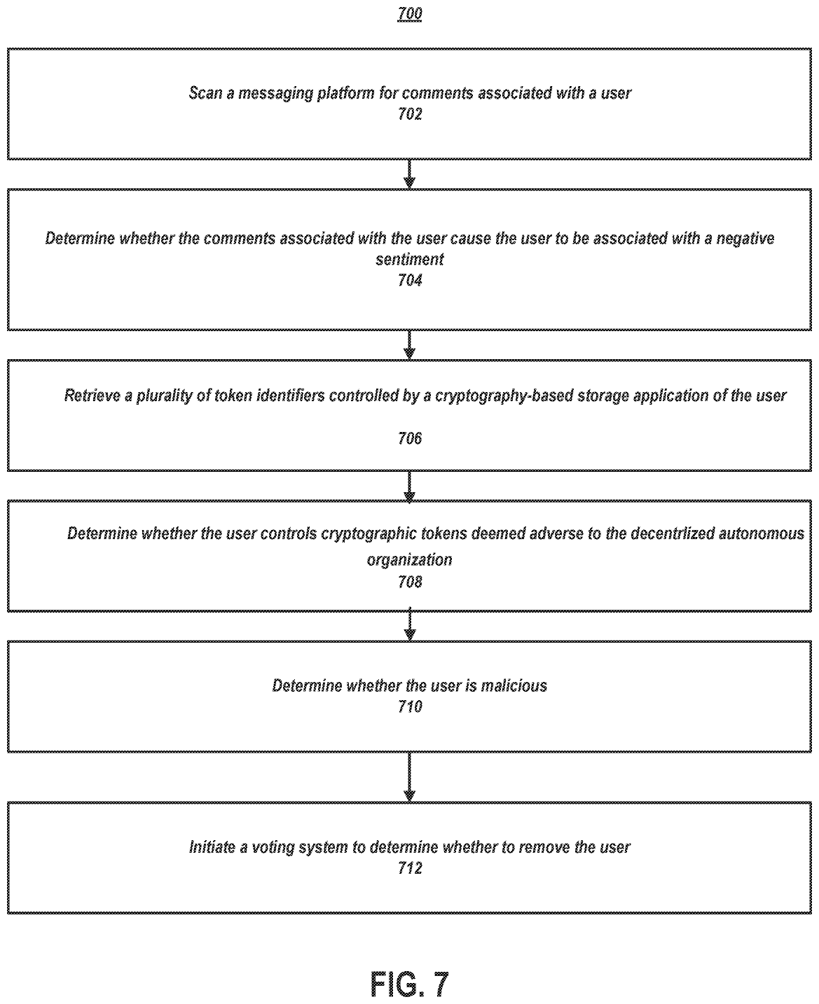

FIG. 7 shows a flowchart of operations for detecting a malicious user in a DAO, in accordance with one or more embodiments. For example, the system may use process 700 (e.g., as implemented on one or more system components described above) in order to detect a malicious user in a DAO and perform an action based on the detection.

At 702, malicious user detection system 102 (e.g., using one or more components described above) scans messaging platform 110. For example, the malicious user detection system 102 may scan messaging platform 110 associated with a DAO for comments associated with a user. Messaging platform 110 may include software components, hardware components, or a combination of both. For example, messaging platform 110 may include software components (e.g., code) that allow users to communicate with one another on the messaging platform. Malicious user detection system 102 may use sentiment detection subsystem 112 and data node 104. Malicious user detection system 102 may use one or more processors and/or network components to perform this operation.

At 704, malicious user detection system 102 (e.g., using one or more components described above) determines whether the user is associated with negative sentiment. For example, malicious user detection system 102 may determine whether the comments associated with the user cause the user to be associated with a negative sentiment. For example, malicious user detection system 102 may analyze comments made by the user using natural learning processing techniques such as sentiment analysis to determine whether the user should be associated with a negative sentiment. For example, the user may comment, “This token is nonsense.” The machine learning model (e.g., model 302) may flag this as negative sentiment towards the DAO. Malicious user detection system 102 may use sentiment detection subsystem 112, data node 104, data structure 200, and model 302. Malicious user detection system 102 may use one or more processors to perform this operation.

At 706, malicious user detection system 102 (e.g., using one or more components described above) retrieves token identifiers that correspond to the cryptographic tokens controlled by a cryptography-based storage application of the user. For example, malicious user detection system 102 may retrieve, from a blockchain node, a plurality of token identifiers corresponding to a plurality of cryptographic tokens controlled by a cryptography-based storage application of the user. For example, when the malicious user detection system is assessing whether the user is malicious, it may retrieve the user device (e.g., a smartphone) of the user that hosts a digital wallet that is able to control cryptographic tokens associated with the DAO. As such, when a user is associated with negative sentiment, malicious user detection system 102 may receive a list of non-fungible tokens and/or other types of cryptographic tokens. Malicious user detection system 102 may analyze the list of cryptographic tokens to acquire information associated with those cryptographic tokens. Malicious user detection system 102 may use data structure 400. Malicious user detection system 102 may use one or more processors and/or network components to perform this operation.

At 708, malicious user detection system 102 (e.g., using one or more components described above) determines whether the user controls any cryptographic tokens deemed adverse to the DAO. For example, malicious user detection system 102 may determine, based on the plurality of token identifiers, whether the user controls cryptographic tokens deemed adverse to the DAO. For example, malicious user detection system 102 may determine whether the user device hosts a digital wallet that controls any cryptographic tokens associated with the adverse DAO. Malicious user detection system 102 may use one or more processors to perform this operation.

At 710, malicious user detection system 102 (e.g., using one or more components described above) may determine whether the user is malicious. For example, malicious user detection system 102 may determine, based on whether the comments associated with the user cause the user to be associated with the negative sentiment and on whether the user controls the cryptographic tokens deemed adverse to the DAO, whether the user is malicious. For example, malicious user detection system 102 may determine whether the user is malicious using the results of the malicious message detection machine learning model and sentiment analysis. Malicious user detection system 102 may use one or more processors to perform this operation.

At 712, malicious user detection system 102 (e.g., using one or more components described above) initiates a vote to determine whether to remove the user from the DAO. For example, malicious user detection system 102 may in response to determining that the user is malicious, initiate a voting system to determine whether to remove the user from the DAO. For example, malicious user detection system 102 may send a voting request to the members of the DAO on whether to remove the malicious user. For example, after the machine learning model (e.g., model 302) has flagged the user for negative sentiment, and it has been determined that the user controls cryptographic tokens for one or more competing DAOs, the system may send a voting request to each member within the DAO. Malicious user detection system 102 may use data structure 600 (e.g., voting request) to do so. Malicious user detection system 102 may use one or more processors to perform this operation.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 7.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real-time. It should also be noted that the systems and/or methods described above may be applied to or used in accordance with other systems and/or methods.

The present techniques will be better understood with reference to the following enumerated embodiments:

1. A method for recognizing malicious users in decentralized autonomous organizations, the method comprising: scanning a messaging platform associated with a decentralized autonomous organization for comments associated with a user; determining whether the comments associated with the user cause the user to be associated with a negative sentiment; retrieving, from a blockchain node, a plurality of token identifiers corresponding to a plurality of cryptographic tokens controlled by a cryptography-based storage application of the user; determining, based on the plurality of token identifiers, whether the user controls cryptographic tokens deemed adverse to the decentralized autonomous organization; determining based on whether the comments associated with the user cause the user to be associated with the negative sentiment and on whether the user controls the cryptographic tokens deemed adverse to the decentralized autonomous organization, whether the user is malicious; and in response to determining that the user is malicious, initiating a voting system to determine whether to remove the user from the decentralized autonomous organization.
2. The method of any one of the preceding embodiments, wherein scanning the messaging platform is performed in response to detecting, in the messaging platform, a malicious comment associated with the user.
3. The method of any one of the preceding embodiments, wherein initiating the voting system further comprises: retrieving a user identifier of the user; and transmitting a voting request to a computing device associated with the decentralized autonomous organization, wherein the voting request comprises the user identifier and a message indicating that the user is malicious, and wherein the voting request asks other users to indicate whether the user should be removed from the decentralized autonomous organization.
4. The method of any one of the preceding embodiments, further comprising in response to determining to remove the user from the decentralized autonomous organization, triggering an on-chain program to remove a cryptographic address associated with the cryptography-based storage application of the user as a controlling address of one or more cryptographic tokens associated with the decentralized autonomous organization.
5. The method of any one of the preceding embodiments, further comprising: in response to determining to remove the user from the decentralized autonomous organization: retrieving a cryptographic address associated with the cryptography-based storage application of the user; and transmitting a command to an on-chain program to add the cryptographic address to a blocklist, wherein the on-chain program prevents cryptographic addresses on the blocklist from controlling any cryptographic tokens associated with the decentralized autonomous organization.
6. The method of any one of the preceding embodiments, further comprising: receiving a request to join the decentralized autonomous organization; identifying a cryptographic address associated with the cryptography-based storage application of the user; and storing the cryptographic address and a user identifier of the user.
7. The method of any one of the preceding embodiments, wherein determining whether the user controls the cryptographic tokens deemed adverse to the decentralized autonomous organization further comprises: retrieving a first plurality of token identifiers associated with the cryptographic tokens associated a different decentralized autonomous organization, wherein the cryptographic tokens are deemed adverse to the decentralized autonomous organization; retrieving, based on the cryptographic address, a second plurality of token identifiers associated with tokens controlled by the cryptography-based storage application of the user; and determining, whether one or more token identifiers of the first plurality of token identifiers matches a token identifier in the second plurality of token identifiers.
8. The method of any one of the preceding embodiments, wherein removing a malicious user from the decentralized autonomous organization further comprises: retrieving a cryptographic address associated with the cryptography-based storage application of the user; determining, via the blockchain node, one or more cryptographic tokens associated with the decentralized autonomous organization controlled by the cryptographic address; and removing the cryptographic address from a control field within the one or more cryptographic tokens.
9. A tangible, non-transitory, machine-readable medium storing instructions that, when executed by a data processing apparatus, cause the data processing apparatus to perform operations comprising those of any of embodiments 1-8 .
10. A system comprising one or more processors; and memory storing instructions that, when executed by the processors, cause the processors to effectuate operations comprising those of any of embodiments 1-8.
11. A system comprising means for performing any of embodiments 1-8.

What is claimed is:

1. A system for recognizing malicious users in decentralized autonomous organizations, the system comprising:
one or more processors; and
a non-transitory computer-readable storage medium storing instructions, which when executed by the one or more processors cause the one or more processors to perform operations comprising:
detecting, in a messaging platform associated with a decentralized autonomous organization, a malicious comment associated with a user;
in response to detecting the malicious comment, scanning the messaging platform for other comments associated with the user;
determining, based on scanning the messaging platform for the other comments associated with the user, whether the other comments of the user cause the user to be associated with a negative sentiment;
retrieving an identifier of a cryptography-based storage application of the user;
based on the identifier, retrieving, from a blockchain node, a plurality of token identifiers corresponding to a plurality of cryptographic tokens controlled by the user;
determining, based on the plurality of cryptographic tokens, whether the user controls cryptographic tokens associated with a different decentralized autonomous organization;
determining based on whether the other comments of the user cause the user to be associated with the negative sentiment and on whether the user controls the cryptographic tokens associated with the different decentralized autonomous organization, whether the user is a malicious user;
in response to determining that the user is the malicious user, transmitting a voting request to a computing device associated with the decentralized autonomous organization, wherein the voting request comprises a user identifier and a message indicating that the user is malicious, and wherein the voting request asks other users to indicate whether the user should be removed from the decentralized autonomous organization; and
based on a result of the voting request indicating removal, removing the malicious user from the decentralized autonomous organization.

2. The system of claim 1, wherein the instructions further cause the one or more processors to perform operations comprising:
receiving a request to join the decentralized autonomous organization;
identifying a cryptographic address associated with the cryptography-based storage application of the user; and
storing the cryptographic address and the user identifier of the user.

3. The system of claim 2, wherein the instructions for determining whether the user controls the cryptographic tokens associated with the different decentralized autonomous organization cause the one or more processors to perform operations comprising:
retrieving a first plurality of token identifiers associated with the cryptographic tokens associated the different decentralized autonomous organization, wherein the cryptographic tokens are deemed adverse to the decentralized autonomous organization;
retrieving, based on the cryptographic address, a second plurality of token identifiers associated with tokens controlled by the cryptography-based storage application of the user; and
determining, whether one or more token identifiers of the first plurality of token identifiers matches a token identifier in the second plurality of token identifiers.

4. The system of claim 1, wherein the instructions for removing the malicious user from the decentralized autonomous organization cause the one or more processors to perform operations comprising:
retrieving a cryptographic address associated with the cryptography-based storage application of the user;
determining, via the blockchain node, one or more cryptographic tokens associated with the decentralized autonomous organization controlled by the cryptographic address; and
removing the cryptographic address from a control field within the one or more cryptographic tokens.

5. A method for recognizing malicious users in decentralized autonomous organizations, the method comprising:
scanning a messaging platform associated with a decentralized autonomous organization for comments associated with a user;
determining whether the comments associated with the user cause the user to be associated with a negative sentiment;
retrieving, from a blockchain node, a plurality of token identifiers corresponding to a plurality of cryptographic tokens controlled by a cryptography-based storage application of the user;
determining, based on the plurality of token identifiers, whether the user controls cryptographic tokens deemed adverse to the decentralized autonomous organization;
determining based on whether the comments associated with the user cause the user to be associated with the negative sentiment and on whether the user controls the cryptographic tokens deemed adverse to the decentralized autonomous organization, whether the user is malicious; and
in response to determining that the user is malicious, initiating a voting system to determine whether to remove the user from the decentralized autonomous organization.

6. The method of claim 5, wherein scanning the messaging platform is performed in response to detecting, in the messaging platform, a malicious comment associated with the user.

7. The method of claim 5, wherein initiating the voting system further comprises:
retrieving a user identifier of the user; and
transmitting a voting request to a computing device associated with the decentralized autonomous organization, wherein the voting request comprises the user identifier and a message indicating that the user is malicious, and wherein the voting request asks other users to indicate whether the user should be removed from the decentralized autonomous organization.

8. The method of claim 7, further comprising in response to determining to remove the user from the decentralized autonomous organization, triggering an on-chain program to remove a cryptographic address associated with the cryptography-based storage application of the user as a controlling address of one or more cryptographic tokens associated with the decentralized autonomous organization.

9. The method of claim 5, further comprising:
in response to determining to remove the user from the decentralized autonomous organization:
retrieving a cryptographic address associated with the cryptography-based storage application of the user; and
transmitting a command to an on-chain program to add the cryptographic address to a blocklist, wherein the on-chain program prevents cryptographic addresses on the blocklist from controlling any cryptographic tokens associated with the decentralized autonomous organization.

10. The method of claim 5, further comprising:
receiving a request to join the decentralized autonomous organization;
identifying a cryptographic address associated with the cryptography-based storage application of the user; and
storing the cryptographic address and a user identifier of the user.

11. The method of claim 10, wherein determining whether the user controls the cryptographic tokens deemed adverse to the decentralized autonomous organization further comprises:
retrieving a first plurality of token identifiers associated with the cryptographic tokens associated a different decentralized autonomous organization, wherein the cryptographic tokens are deemed adverse to the decentralized autonomous organization;
retrieving, based on the cryptographic address, a second plurality of token identifiers associated with tokens controlled by the cryptography-based storage application of the user; and
determining, whether one or more token identifiers of the first plurality of token identifiers matches a token identifier in the second plurality of token identifiers.

12. The method of claim 5, wherein removing a malicious user from the decentralized autonomous organization further comprises:
retrieving a cryptographic address associated with the cryptography-based storage application of the user;
determining, via the blockchain node, one or more cryptographic tokens associated with the decentralized autonomous organization controlled by the cryptographic address; and
removing the cryptographic address from a control field within the one or more cryptographic tokens.

13. A non-transitory, computer-readable storage medium storing instructions that when executed by one or more processors cause the one or more processors to perform operations comprising:
scanning a messaging platform associated with a decentralized autonomous organization for comments associated with a user;
determining whether the comments associated with the user cause the user to be associated with a negative sentiment;
retrieving, from a blockchain node, a plurality of token identifiers corresponding to a plurality of cryptographic tokens controlled by a cryptography-based storage application of the user;
determining, based on the plurality of token identifiers, whether the user controls cryptographic tokens deemed adverse to the decentralized autonomous organization;
determining based on whether the comments associated with the user cause the user to be associated with the negative sentiment and on whether the user controls the cryptographic tokens deemed adverse to the decentralized autonomous organization, whether the user is malicious; and
in response to determining that the user is malicious, blocking transfer of one or more cryptographic tokens controlled by the user.

14. The non-transitory, computer-readable storage medium of claim 13, wherein the instructions cause the one or more processors to scan the messaging platform in response to detecting, in the messaging platform, a malicious comment associated with the user.

15. The non-transitory, computer-readable storage medium of claim 13, wherein the instructions for initiating a voting system cause the one or more processors to perform operations comprising:
retrieving a user identifier of the user; and
transmitting a voting request to a computing device associated with the decentralized autonomous organization, wherein the voting request comprises the user identifier and a message indicating that the user is malicious, and wherein the voting request asks other users to indicate whether the user should be removed from the decentralized autonomous organization.

16. The non-transitory, computer-readable storage medium of claim 15, wherein the instructions further cause the one or more processors to, in response to determining to remove the user from the decentralized autonomous organization, trigger an on-chain program to remove a cryptographic address associated with the cryptography-based storage application of the user as a controlling address of one or more cryptographic tokens associated with the decentralized autonomous organization.

17. The non-transitory, computer-readable storage medium of claim 13, wherein the instructions further cause the one or more processors to perform operations comprising:
in response to determining to remove the user from the decentralized autonomous organization:
retrieving a cryptographic address associated with the cryptography-based storage application of the user; and
transmitting a command to an on-chain program to add the cryptographic address to a blocklist, wherein the on-chain program prevents cryptographic addresses on the blocklist from controlling any cryptographic tokens associated with the decentralized autonomous organization.

18. The non-transitory, computer-readable storage medium of claim 13, wherein the instructions further cause the one or more processors to perform operations comprising:
receiving a request to join the decentralized autonomous organization;
identifying a cryptographic address associated with the cryptography-based storage application of the user; and
storing the cryptographic address and a user identifier of the user.

19. The non-transitory, computer-readable storage medium of claim 18, wherein the instructions for determining whether the user controls the cryptographic tokens deemed adverse to the decentralized autonomous organization further cause the one or more processors to perform operations comprising:
retrieving a first plurality of token identifiers associated with the cryptographic tokens associated a different decentralized autonomous organization, wherein the cryptographic tokens are deemed adverse to the decentralized autonomous organization;
retrieving, based on the cryptographic address, a second plurality of token identifiers associated with tokens controlled by the cryptography-based storage application of the user; and
determining, whether one or more token identifiers of the first plurality of token identifiers matches a token identifier in the second plurality of token identifiers.

20. The non-transitory, computer-readable storage medium of claim 13, wherein the instructions for removing a malicious user from the decentralized autonomous organization further cause the one or more processors to perform operations comprising:
retrieving a cryptographic address associated with the cryptography-based storage application of the user;
determining, via the blockchain node, one or more cryptographic tokens associated with the decentralized autonomous organization controlled by the cryptographic address; and
removing the cryptographic address from a control field within the one or more cryptographic tokens.
